(19) United States
(12) Patent Application Publication
(10) Pub. No.: US 2024/0399636 A1
(43) Pub. Date: Dec. 5, 2024

(54) PVC FLOORING, AND PRODUCTION LINE AND PREPARATION METHOD THEREOF

(71) Applicant: WUXI BOYU PLASTIC MACHINERY CO., LTD., Wuxi (CN)

(72) Inventor: Dingyi LU, Wuxi (CN)

(73) Assignee: WUXI BOYU PLASTIC MACHINERY CO., LTD., Wuxi (CN)

(21) Appl. No.: 18/700,720

(22) PCT Filed: Oct. 10, 2022
(86) PCT No.: PCT/CN2022/124430

§ 371 Date: Apr. 12, 2024

(30) Foreign Application Priority Data
Oct. 14, 2021 (CN) 202111199870.2

(51) Int. Cl. B29C 48/00; B29C 43/00; B29C 43/22; B29C 43/24; B29C 43/30; B29C 43/46; B29C 43/52; B29C 48/07; B29C 48/88; B29C 59/04; B29D 7/01; B29K 27/06; B29K 105/04; B29L 31/00; B32B 5/02; B32B 5/18; B32B 5/24; B32B 27/06; B32B 27/12; B32B 27/30

(52) U.S. Cl. CPC B29C 48/0011; B29C 43/003; B29C 43/222; B29C 43/24; B29C 43/305; B29C 43/46; B29C 43/52; B29C 48/0022; B29C 48/022; B29C 48/07; B29C 48/9135; B29C 59/046; B29D 7/01; B32B 5/02; B32B 5/18; B32B 5/245; B32B 27/065; B32B 27/12; B32B 27/304; B29K 2027/06; B29K 2105/04; B29K 2995/0063; B29L 2031/732; B32B 2255/26; B32B 2255/28; B32B 2262/101; B32B 2266/0235; B32B 2471/00

(57) ABSTRACT

A polyvinyl chloride (PVC) flooring, and a production line and a preparation method thereof are provided. The production line includes a loading system, an internal-mixing extrusion device, a calendering lamination device, a cooling device, a tractor, and a cutter that are arranged sequentially along a material conveying direction, where the internal-mixing extrusion device includes an internal mixing mechanism, an extrusion mechanism, and a hopper. In an internal mixing stage of the internal-mixing extrusion device, materials are quickly dispersed and plasticized, and plasticized materials directly enter an extruding stage through the hopper for extrusion molding. The production line achieves a desirable plasticization effect, and prevents the problem that a PVC hard product without a plasticizer is forcibly plasticized by a conventional extruder to cause a poor plasticization effect. Without passing through a high-speed mixer, the plasticized materials are directly extruded.

### CROSS REFERENCE TO THE RELATED APPLICATIONS

This application is the national phase entry of International Application No. PCT/CN2022/124430, filed on Oct. 10, 2022, which is based upon and claims priority to Chinese Patent Application No. 202111199870.2, filed on Oct. 14, 2021, the entire contents of which are incorporated herein by reference.

### TECHNICAL FIELD

The present disclosure relates to the technical field of flooring manufacturing, and in particular to a polyvinyl chloride (PVC) flooring, and a production line and a preparation method thereof.

### BACKGROUND

In an extrusion stage of existing PVC flooring production, materials are mixed by a high-speed mixer to about 120° C., discharged to a cooling mixer for cooling, and plasticized forcibly by a conical twin-screw extruder with a good shear force. This process is highly energy-consuming. Specifically, the materials are first heated for about 20-40 min, cooled at a high temperature, and discharged to the extruder heated to 190-200° C. In the extruder, the materials are plasticized, and extruded into a panel. By heating the materials to 120-135° C. through the high-speed mixer and then cooling the materials to about 50° C. through the cooling mixer, there is a temperature difference of 70-85° C. which causes high energy consumption, long mixing time, and a high mixing cost. Moreover, the materials are plasticized only by means of forced shearing and frictional heating of a screw of the extruder. For a PVC hard product without a plasticizer, a plasticization effect is undesirable.

### SUMMARY

The present disclosure is intended to solve at least one of the technical problems in the prior art. In view of this, the present disclosure provides a PVC flooring, and a production line and a preparation method thereof. The production line can lower energy consumption, shorten material mixing and extruding time, reduce a cost, and optimize a plasticization effect, and is applicable to a PVC hard product without a plasticizer.

According to a first aspect of the present disclosure, an embodiment provides a PVC flooring production line, including a loading system, an internal-mixing extrusion device, a calendering lamination device, a cooling device, a tractor, and a cutter that are arranged sequentially along a material conveying direction, where a film unwinding mechanism is provided on a top of the calendering lamination device; a delivery track is provided along the calendering lamination device, the cooling device, the tractor, and the cutter; the internal-mixing extrusion device includes an internal mixing mechanism, an extrusion mechanism, and a hopper; the internal mixing mechanism includes a mixing chamber; a rear end of the mixing chamber is provided with a first feed port, and a front end of the mixing chamber is provided with a first discharge port; a rotor is provided in the mixing chamber along a front-rear direction; the extrusion mechanism is located below the internal mixing mechanism; the extrusion mechanism includes an extruding chamber; a rear end of the extruding chamber is provided with a second feed port, and a front end of the extruding chamber is provided with a mold; a screw is provided in the extruding chamber along the front-rear direction; and the hopper is connected between the first discharge port and the second feed port.

According to some embodiments of the present disclosure, the rotor is a double-kneading structure; the rotor includes a rotor shaft; and a material conveying segment, a first mixing segment, a first helical segment, a second mixing segment, and a first discharge segment are arranged sequentially on the rotor shaft. With the rotor, the materials can be effectively filled in the whole mixing chamber in internal mixing. With a high fill rate and a good dispersity, the rotor is applicable to a temperature-sensitive material, and makes the material plasticized desirably.

According to some preferred embodiments of the present disclosure, a second helical segment is further provided between the second mixing segment and the first discharge segment. The whole rotor is lengthened to facilitate discharge of the materials. Before discharged, the original blocky materials are cut into small bulk materials or large granular materials. This facilitates conveyance of the materials to the extruding chamber, and can further improve the plasticization effect and shorten the time.

According to some embodiments of the present disclosure, the rotor is a single-kneading structure; the rotor includes a rotor shaft; and a material conveying segment, a mixing segment, and a second discharge segment are arranged sequentially on the rotor shaft. The rotor has a strong universality and a good material conveying stability.

According to some preferred embodiments of the present disclosure, a third helical segment is further provided between the mixing segment and the second discharge segment. The whole rotor is lengthened to facilitate discharge of the materials. Before discharged, the original blocky materials are cut into small bulk materials or large granular materials. This facilitates conveyance of the materials to the extruding chamber, and can further improve the plasticization effect and shorten the time.

According to some embodiments of the present disclosure, a forced feeding device is provided in the hopper; the forced feeding device includes two parallel rotating shafts; a blade is provided on each of the rotating shafts; and the two rotating shafts rotate relatively.

According to some embodiments of the present disclosure, the two rotating shafts are respectively driven by a driving gear and a driven gear that are engaged to each other.

According to some embodiments of the present disclosure, the screw refers to conical twin screws, a single screw or parallel twin screws.

According to some embodiments of the present disclosure, the loading system includes a vacuum loader, a loss-in-weight feeder, and a mixing bunker that are connected sequentially; a discharge port of the mixing bunker is provided with a screw batcher; and the discharge port of the mixing bunker is connected to the first feed port. The materials are conveyed to the loss-in-weight feeder through the vacuum loader. The loss-in-weight feeder is used to accurately mix the materials. The mixed materials are temporarily stored in the mixing bunker. The materials are fed by the screw batcher to the internal-mixing extrusion device. The materials directly enter the internal-mixing extrusion device for internal mixing and extrusion, without passing through the high-speed mixer.

According to some embodiments of the present disclosure, the calendering lamination device is one of a three-roll calender, a four-roll calender or a five-roll calender. In combination with calendering and laminating or embossing, the calender can realize thickness fixing and surface effect treatment of a substrate.

According to some embodiments of the present disclosure, the calendering lamination device is a five-roll calender; the five-roll calender includes a thickness fixing roll set, a pre-laminating roll set, and a pressing roll set; the pressing roll set includes an embossing roll; and the embossing roll is provided with a water cooling device. The extruded substrate is calendered through the thickness fixing roll set to obtain a target thickness, and then laminated and embossed by the pre-laminating roll set and the pressing roll set. The five-roll calender can press and form a substrate layer, a printed layer, and a wear layer conveniently and quickly, and can produce a clear and sharp embossed pattern.

According to some embodiments of the present disclosure, the calendering lamination device may further be a calendering lamination line composed of a thickness fixing roll and a plurality of lamination units; the thickness fixing roll is located at a front end of the calendering lamination line; the plurality of lamination units are sequentially connected behind the thickness fixing roll; a number of the lamination units is increased or decreased according to a product requirement; the film unwinding mechanism is located above the lamination units; the lamination units each include a preheating roll, a laminating roll, and a roll table conveyance line for conveying a material; further, the roll table conveyance line may be provided with a preheating system; and further, a tail end of the calendering lamination line is further provided with an embossing roll. The extruded substrate is calendered through the thickness fixing roll. Sequentially passing through the plurality of lamination unit, the substrate is laminated. The laminated substrate passes through the embossing roll at last.

According to some embodiments of the present disclosure, an automatic panel lifter is further provided behind the cutter. The automatic panel lifter is used to stack a cut panel.

According to some embodiments of the present disclosure, two or more internal-mixing extrusion devices are arranged to form a co-extrusion system. Through a co-extrusion process, an ABA composite substrate and an ABC composite substrate may be obtained.

The present disclosure further provides a preparation method of a PVC flooring, which uses the PVC flooring production line, and includes the following steps:
S1: putting a raw material into the loading system, and subjecting the raw material to internal mixing and extrusion molding through the internal-mixing extrusion device to obtain a PVC base plate; and
S2: driving, by the tractor, the PVC base plate to enter the calendering lamination device for thickness fixing and film lamination and then enter the cooling device for cooling, and cutting the PVC base plate by the cutter, so as to obtain the PVC flooring.

According to some embodiments of the present disclosure, the raw material includes PVC and stone powder; a mass ratio of the PVC to the stone powder is 1:(2-5); and further, the raw material may not include a plasticizer.

According to some embodiments of the present disclosure, the raw material further includes a foaming agent; and the obtained PVC flooring has a density of 1.3-1.8 g/cm³.

According to some embodiments of the present disclosure, the film unwinding mechanism uses one or more of a luxury vinyl tile (LVT) coiled material, a glass fiber coiled material or a polymer film according to a product requirement; and two or more coating layers made of a same material or different materials are provided on the PVC base plate.

The present disclosure further provides a PVC flooring prepared by the preparation method.

According to a preferred implementation of the present disclosure, the present disclosure at least has the following beneficial effects: In an internal mixing stage of the internal-mixing extrusion device, materials are quickly dispersed and plasticized, and plasticized materials directly enter an extruding stage through the hopper for extrusion molding. The production line provided by the present disclosure achieves a desirable plasticization effect, and prevents the problem that a PVC hard product without a plasticizer is forcibly plasticized by a conventional extruder to cause a poor plasticization effect. Without passing through a high-speed mixer, the plasticized materials are directly extruded. This shortens material mixing and extruding time, lowers energy consumption, and reduces usage amounts of a stabilizer, an internal lubricant and an external lubricant in a material formula. The production line provided by the present disclosure has a high degree of automation, and can realize continuous and efficient production of PVC floorings.

### BRIEF DESCRIPTION OF THE DRAWINGS

The above and/or additional aspects and advantages of the present disclosure will become apparent and easy to understand from the description of the embodiments with reference to the following drawings, in which:

FIG. 1 is a schematic view of an overall structure according to an embodiment of the present disclosure;

FIG. 2 is a schematic structural view of an internal-mixing extrusion device 200 according to the present disclosure;

FIG. 3 is a first schematic structural view of a rotor 1000 according to the present disclosure;

FIG. 4 is a second schematic structural view of a rotor 1000 according to the present disclosure;

FIG. 5 is a third schematic structural view of a rotor 1000 according to the present disclosure; and

FIG. 6 is a fourth schematic structural view of a rotor 1000 according to the present disclosure.

In the figures: 110: vacuum loader, 120: loss-in-weight feeder, 130: mixing bunker, 200: internal-mixing extrusion device, 210: internal mixing mechanism, 211: mixing chamber, 212: first feed port, 213: first discharge port, 220: extrusion mechanism, 221: extruding chamber, 222: second feed port, 223: mold, 224: screw, 230: hopper, 231: forced feeding device, 300: five-roll calender, 400: cooling device, 500: tractor, 600: cutter, 700: automatic panel lifter, 800: film unwinding mechanism, 900: delivery track, 1000: rotor, 1010: rotor shaft, 1020: material conveying segment, 1030: first mixing segment, 1040: first helical segment, 1050: second mixing segment, 1060: first discharge segment, 1070: second helical segment, 1080: mixing segment, 1090: second discharge segment, and 1100: third helical segment.

### DETAILED DESCRIPTION OF THE EMBODIMENTS

The embodiments of the present disclosure are described below in detail. Examples of the embodiments are shown in the drawings. The same or similar numerals represent the same or similar elements or elements having the same or similar functions throughout the specification. The embodiments described below with reference to the accompanying drawings are exemplary. These embodiments are merely used to explain the present disclosure, and should not be construed as a limitation to the present disclosure.

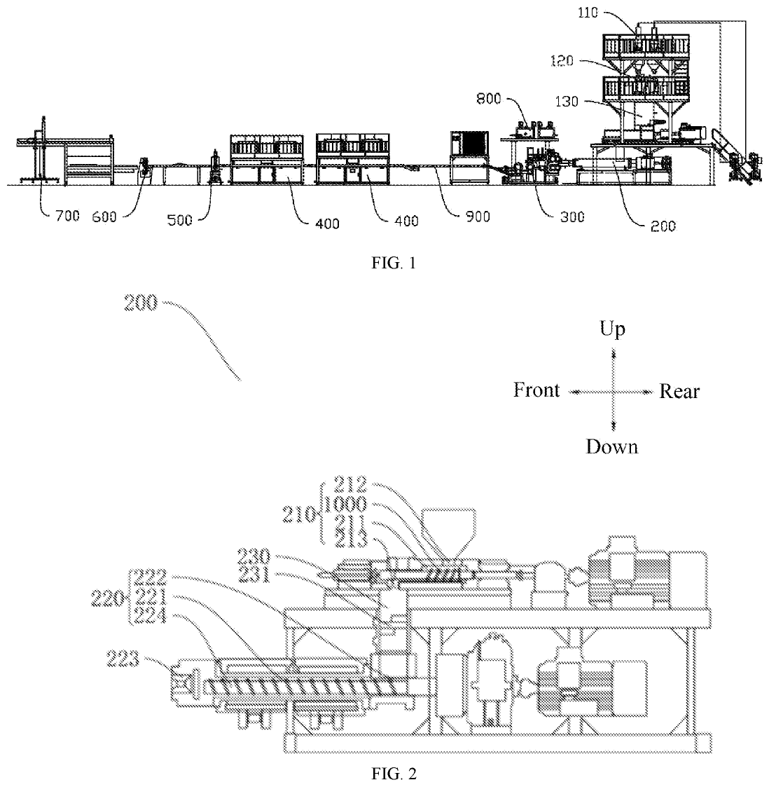

Referring to FIGS. 1-2, a PVC flooring production line includes a loading system, internal-mixing extrusion device 200, five-roll calender 300, cooling device 400, tractor 500, cutter 600, and automatic panel lifter 700 that are arranged sequentially along a material conveying direction. Film unwinding mechanism 800 is provided on a top of the five-roll calender 300. Delivery track 900 is provided along the five-roll calender 300, the cooling device 400, the tractor 500, and the cutter 600. The loading system includes vacuum loader 110, loss-in-weight feeder 120, and mixing bunker 130 that are connected sequentially. A discharge port of the mixing bunker 130 is provided with a screw batcher. The discharge port of the mixing bunker 130 is connected to first feed port 212. The internal-mixing extrusion device 200 includes internal mixing mechanism 210, extrusion mechanism 220, and hopper 230. The internal mixing mechanism 210 includes mixing chamber 211. A rear end of the mixing chamber 211 is provided with the first feed port 212, and a front end of the mixing chamber 211 is provided with first discharge port 213. Rotor 1000 is provided in the mixing chamber 211 along a front-rear direction. The extrusion mechanism 220 is located below the internal mixing mechanism 210. The extrusion mechanism 220 includes extruding chamber 221. A rear end of the extruding chamber 221 is provided with second feed port 222, and a front end of the extruding chamber 221 is provided with mold 223. Screw 224 is provided in the extruding chamber 221 along the front-rear direction. The hopper 230 is connected between the first discharge port 213 and the second feed port 222. Forced feeding device 231 is provided in the hopper 230. The forced feeding device 231 includes two parallel rotating shafts. A blade is provided on each of the rotating shafts. The two rotating shafts rotate relatively. The two rotating shafts are respectively driven by a driving gear and a driven gear that are engaged to each other. The five-roll calender 300 includes a thickness fixing roll set, a pre-laminating roll set, and a pressing roll set. The pressing roll set includes an embossing roll. The embossing roll is provided with a water cooling device.

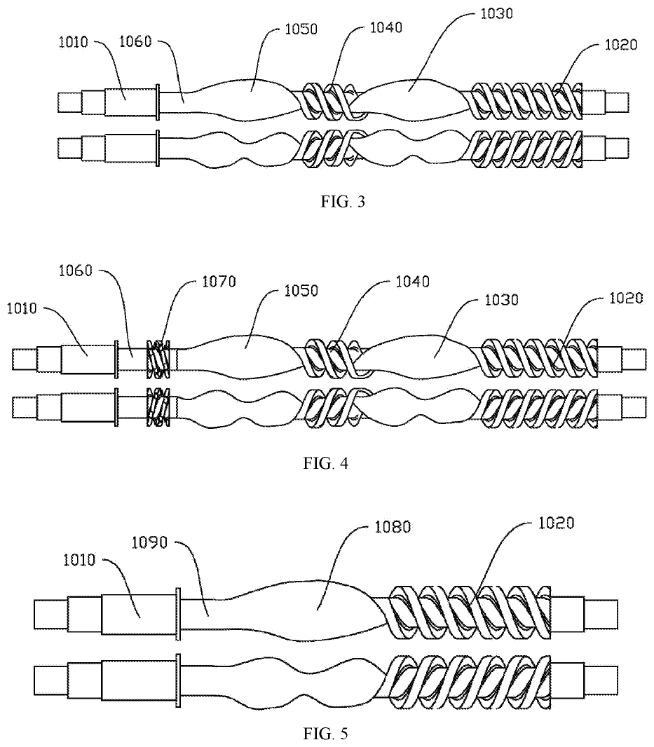

In some embodiments, referring to FIG. 3, the rotor 1000 is a double-kneading structure. The rotor 1000 includes rotor shaft 1010. Material conveying segment 1020, first mixing segment 1030, first helical segment 1040, second mixing segment 1050, and first discharge segment 1060 are arranged sequentially on the rotor shaft 1010. With the rotor, the materials can be effectively filled in the whole mixing chamber in internal mixing. With a high fill rate and a good dispersity, the rotor is applicable to a temperature-sensitive material, and makes the material plasticized desirably.

In some embodiments, referring to FIG. 4, the rotor 1000 is a double-kneading structure. The rotor 1000 includes rotor shaft 1010. Material conveying segment 1020, first mixing segment 1030, first helical segment 1040, second mixing segment 1050, and first discharge segment 1060 are arranged sequentially on the rotor shaft 1010. Second helical segment 1070 is further provided between the second mixing segment 1050 and the first discharge segment 1060. The whole rotor is lengthened to facilitate discharge of the materials. Before discharged, the original blocky materials are cut into small bulk materials or large granular materials. This facilitates conveyance of the materials to the extruding chamber, and can further improve the plasticization effect and shorten the time.

In some embodiments, referring to FIG. 5, the rotor 1000 is a single-kneading structure. The rotor 1000 includes rotor shaft 1010. Material conveying segment 1020, mixing segment 1080, and second discharge segment 1090 are arranged sequentially on the rotor shaft 1010. The rotor has a strong universality and a good material conveying stability.

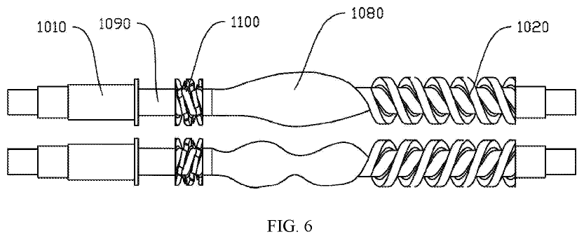

In some embodiments, referring to FIG. 6, the rotor 1000 is a single-kneading structure. The rotor 1000 includes rotor shaft 1010. Material conveying segment 1020, mixing segment 1080, and second discharge segment 1090 are arranged sequentially on the rotor shaft 1010. Third helical segment 1100 is further provided between the mixing segment 1080 and the second discharge segment 1090. The whole rotor is lengthened to facilitate discharge of the materials. Before discharged, the original blocky materials are cut into small bulk materials or large granular materials. This facilitates conveyance of the materials to the extruding chamber, and can further improve the plasticization effect and shorten the time.

In some embodiments, the screw 224 refers to conical twin screws, a single screw or parallel twin screws.

A preparation method of a PVC flooring uses the PVC flooring production line, and includes the following steps:
S1: A raw material is put into the vacuum loader, and the raw material is subjected to internal mixing and extrusion molding through the internal-mixing extrusion device to obtain a PVC base plate. The raw material includes PVC and stone powder.
S2: The PVC base plate is driven by the tractor to enter the calendering lamination device for thickness fixing and film lamination and then enter the cooling device for cooling, and cut by the cutter, so as to obtain the PVC flooring.

In some embodiments, the raw material includes the PVC and the stone powder at a mass ratio of 1:(2-5). The raw material does not include a plasticizer.

In some embodiments, the raw material further includes a foaming agent. The obtained PVC flooring has a density of 1.3-1.7 g/cm³.

In some embodiments, the film unwinding mechanism uses one or more of an LVT coiled material, a glass fiber coiled material or a polymer film according to a product requirement. Two or more coating layers made of a same material or different materials are provided on the PVC base plate.

The embodiments of the present disclosure have been described in detail above with reference to the accompanying drawings, but the present disclosure is not limited thereto. Within the scope of knowledge possessed by those of ordinary skill in the art, various modifications can be made without departing from the tenet of the present disclosure.

What is claimed is:

1. A polyvinyl chloride (PVC) flooring production line, comprising a loading system, an internal-mixing extrusion device, a calendering lamination device, a cooling device, a tractor, and a cutter, wherein the loading system, the internal-mixing extrusion device, the calendering lamination device, the cooling device, the tractor and the cutter are arranged sequentially along a material conveying direction, wherein a film unwinding mechanism is provided on a top of the calendering lamination device; a delivery track is provided along the calendering lamination device, the cooling device, the tractor, and the cutter; the internal-mixing extrusion device comprises an internal mixing mechanism, an extrusion mechanism, and a hopper; the internal mixing mechanism comprises a mixing chamber; a rear end of the mixing chamber is provided with a first feed port, and a front end of the mixing chamber is provided with a first discharge port; a rotor is provided in the mixing chamber along a front-rear direction; the extrusion mechanism is located below the internal mixing mechanism; the extrusion mechanism comprises an extruding chamber; a rear end of the extruding chamber is provided with a second feed port, and a front end of the extruding chamber is provided with a mold; a screw is provided in the extruding chamber along the front-rear direction; and the hopper is connected between the first discharge port and the second feed port.

2. The PVC flooring production line according to claim 1, wherein the loading system comprises a vacuum loader, a loss-in-weight feeder, and a mixing bunker, wherein the vacuum loader, the loss-in-weight feeder and the mixing bunker are connected sequentially; a discharge port of the mixing bunker is provided with a screw batcher; and the discharge port of the mixing bunker is connected to the first feed port.

3. The PVC flooring production line according to claim 1, wherein the calendering lamination device is a three-roll calender, a four-roll calender or a five-roll calender.

4. The PVC flooring production line according to claim 1, wherein the calendering lamination device is a five-roll calender; the five-roll calender comprises a thickness fixing roll set, a pre-laminating roll set, and a pressing roll set; the pressing roll set comprises an embossing roll; and the embossing roll is provided with a water cooling device.

5. The PVC flooring production line according to claim 1, wherein an automatic panel lifter for stacking a product is provided behind the cutter.

6. The PVC flooring production line according to claim 1, wherein two or more internal-mixing extrusion devices are arranged to form a co-extrusion system.

7. A preparation method of a polyvinyl chloride (PVC) flooring, using the PVC flooring production line according to claim 1, and comprising the following steps:
S1: putting a raw material into the loading system, and subjecting the raw material to internal mixing and extrusion molding through the internal-mixing extrusion device to obtain a PVC base plate; and
S2: driving, by the tractor, the PVC base plate to enter the calendering lamination device for thickness fixing and film lamination and then enter the cooling device for cooling, and cutting the PVC base plate by the cutter, so as to obtain the PVC flooring.

8. The preparation method according to claim 7, wherein the raw material comprises a foaming agent; and the PVC flooring has a density of 1.3-1.8 g/cm³.

9. The preparation method according to claim 7, wherein the film unwinding mechanism uses one or more of a luxury vinyl tile (LVT) coiled material, a glass fiber coiled material or a polymer film according to a product requirement; and two or more coating layers made of a same material or different materials are provided on the PVC base plate.

10. A polyvinyl chloride (PVC) flooring prepared by the preparation method according to claim 7.

11. The PVC flooring according to claim 10, wherein in the preparation method, the raw material comprises a foaming agent; and the PVC flooring has a density of 1.3-1.8 g/cm³.

12. The PVC flooring according to claim 10, wherein in the preparation method, the film unwinding mechanism uses one or more of a luxury vinyl tile (LVT) coiled material, a glass fiber coiled material or a polymer film according to a product requirement; and two or more coating layers made of a same material or different materials are provided on the PVC base plate.
